(19) United States
(12) Patent Application Publication
(10) Pub. No.: US 2002/0082042 A1
(43) Pub. Date: Jun. 27, 2002

(54) Method and apparatus for providing a remote keypad for a mobile station

(75) Inventors: Tony Mark, Vancouver (CA); Seppo Ojanen, Richmond (CA); John Patrick Wong, Vancouver (CA); Michael David Trevorrow, Delta (CA)

Correspondence Address: HARRINGTON & SMITH, LLP, 1809 BLACK ROCK TURNPIKE, FAIRFIELD, CT, 06432, US

(73) Assignee: Nokia Mobil Phones Limited

(21) Appl. No.: 09/745,390

(22) Filed: Dec. 22, 2000

(51) Int. Cl. H04M 1/00

(52) U.S. Cl. 455/550; 455/575; 455/90; 455/41; 345/169

(57) ABSTRACT

A mobile station in accordance with these teachings includes a communication part having a controller, an RF transceiver and an antenna; and that further includes an information entry part embodied as a keypad or a keyboard module that may be detachable from the communication part. The keypad module is coupled, whether attached or detached, through a wireless link to the communication part for conveying keypad-generated information, such as dialed telephone numbers, from the keypad module to the communication part. Preferably the wireless link is a short range, low power RF link, such as a Bluetooth link. The keypad module further includes a source for providing operating power for the keypad module, where the source includes at least one solar cell used alone or in combination with a battery.

### FIELD OF THE INVENTION

This invention relates generally to wireless terminals and communicators, such as cellular telephones, and relates more specifically to user input devices for wireless terminals.

### BACKGROUND OF THE INVENTION

FIG. 1 depicts an exemplary wireless terminal or mobile station (MS) 1. The MS 1 includes a case 2 that contains a microphone 3, a speaker 4, a display 5 and an antenna 6. Of most interest to this invention are a plurality of pushbuttons or keypad keys 7, which are arrayed in the conventional 3×4 telephone matrix, and which enable the user to input the numbers 0-9, the special characters * and #, as well as alphabetic characters. A plurality of special purpose pushbutton keys 8 are also typically provided, such as a Send key, an End key, and various “soft keys” and scrolling keys for enabling the user to interact with various screens shown on the display 5.

In conventional practice the keypad keys 7 and the optional keys 8 are integrated into the MS 1, and the cover 2 is designed so that openings are provided for the keys 7 and 8 to protrude through.

While this arrangement is well-suited for many applications, there are certain applications where other keypad key and possibly special key arrangements would provide a benefit. One such application is a hands-free application, where the user is enabled to communicate without physically holding the body 2 of the MS 1 in his or her hand.

### OBJECTS AND ADVANTAGES OF THE INVENTION

It is a first object and advantage of this invention to provide an improved keypad arrangement for a mobile station.

It is another object and advantage of this invention to provide a self-powered and self-contained keypad or keyboard module that is wirelessly coupled to a mobile station for enabling the user to remotely place telephone calls.

It is another object and advantage of this invention to provide a solar-powered and self-contained keypad module that may be detachable from a mobile station and that is wirelessly coupled to the mobile station for enabling the user to remotely place telephone calls.

It is a further object and advantage of this invention to provide a self-powered keypad module that may be detachable from a mobile station and that is wirelessly coupled to the mobile station through a low power RF link for enabling the user to remotely place telephone calls, where the keypad module includes at least one photovoltaic cell, such as a solar cell, for powering the keypad module.

### SUMMARY OF THE INVENTION

The foregoing and other problems are overcome and the foregoing objects and advantages are realized by methods and apparatus in accordance with embodiments of this invention.

A mobile station in accordance with these teachings includes a communication part having a controller, an RF transceiver and an antenna. The mobile station further includes an information entry part embodied as a keypad module that may or may not be detachable from the communication part. The keypad module is coupled, whether attached or detached, through a wireless link to the communication part for conveying keypad generated information, such as dialed telephone numbers, from the keypad module to the communication part. Preferably the wireless link is a short range, low power RF link, such as a Bluetooth link. The keypad module further includes a source for providing operating power for the keypad module, where the source includes at least one photovoltaic cell used alone or in combination with a battery.

In a further embodiment the keypad module is replaced with a full alphanumeric self-powered keyboard module to facilitate text and data entry through a wireless link, such as the Bluetooth link.

Also disclosed is a method for dialing a telephone number having steps of: (a) providing a keypad module that is detachably coupled to a wireless communication terminal; (b) entering information for specifying a telephone number using a keypad on the keypad module; and (c) whether the keypad module is attached to or detached from the wireless communication terminal, conveying keypad generated information from the keypad module to the wireless communication terminal through a wireless link. The method further includes a step of powering the keypad module using at least one photovoltaic cell located on the keypad module.

An information entry module includes a keypad or a keyboard and an interface for being connected through a wireless link to a wireless communication terminal, such as a cellular telephone, for conveying user-generated keystroke information from the module to the wireless communication terminal. The module further includes at least one solar cell for powering the module. At least one of the wireless communication terminal and the module may be adapted for being mechanically attached to one another and detached from one another.

### BRIEF DESCRIPTION OF THE DRAWINGS

The above set forth and other features of the invention are made more apparent in the ensuing Detailed Description of the Invention when read in conjunction with the attached Drawings, wherein:

FIG. 1 is an elevational view of a conventional mobile station;

FIG. 2 is an elevational view of an exemplary embodiment of a detachable keypad module in accordance with this invention, as well as an example of a mobile station to which the keypad module can be physically attached, where a low power wireless link (RF link) is used to communicate from the keypad module to the mobile station, and where the keypad module includes a photovoltaic cell power source;

FIG. 3 is a circuit block diagram of the keypad module shown in FIG. 2; and

FIG. 4 shows a further embodiment of this invention wherein a self-powered, full function alphanumeric keyboard module is wirelessly coupled to the mobile station.

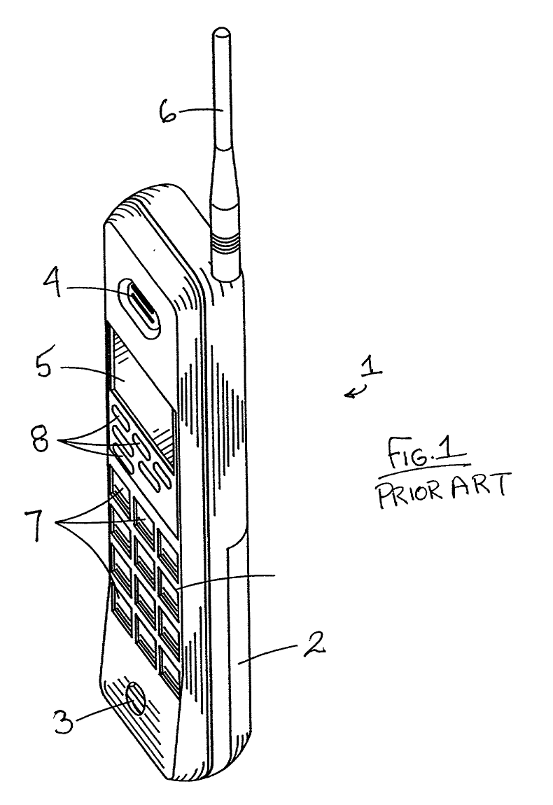

### DETAILED DESCRIPTION OF THE INVENTION

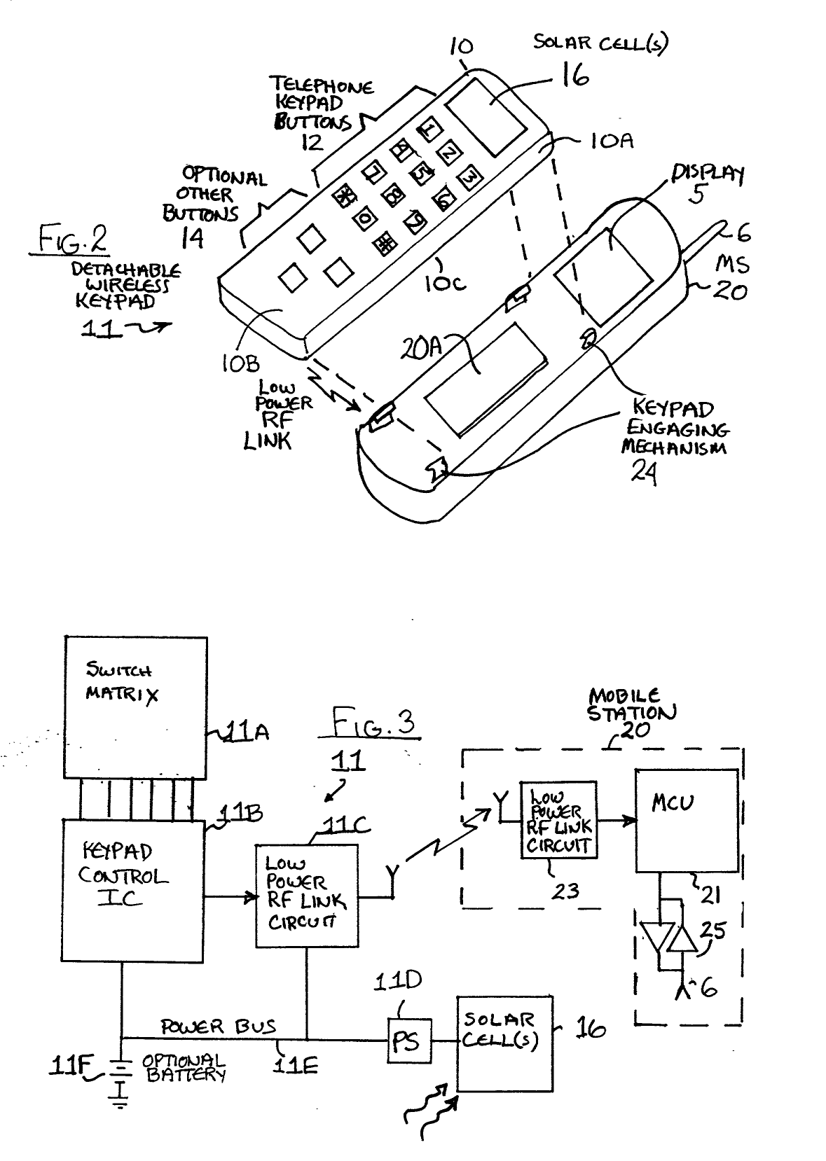

Reference is now made to FIG. 2 for showing an elevational view of one example of a detachable keypad module 11 in accordance with one embodiment of this invention, as well as an example of a mobile station (MS) 20 to which the keypad module 11 can be physically attached using a keypad engaging mechanism 24. The keypad module 11 is constructed to have a body portion 10 with sidewalls 10A, and a top major surface 10B on which or through which a 3×4 array of telephone keypad buttons 12 are positioned. Optional other buttons 14, such as a Send button, an End button, etc., may also be disposed on the top surface 10B. One or more photovoltaic cells, also referred to herein interchangeably as solar cells 16, are also located on the top surface 10B of the keypad module 11 for providing operating power for the keypad module 11. The solar cells 16 are selected for providing a suitable amount of operating power for the keypad module 11 under normal indoor lighting conditions using incandescent or fluorescent lamps, as well as under typical outdoor lighting conditions. Because of the low power nature of the circuitry used in the keypad module 11, including the low power RF link, typically less than 100 milliwatts of operating power is required-an amount that is well within the capabilities of a number of commercially available solar cells.

In the illustrated example the keypad engagement mechanism 24 is comprised of flexible clamps that engage the sidewalls 10A, and possibly also the top surface 10B, of the body 10 of the keypad module 11. However, a number of different types of engaging mechanisms can be used, including placing grooves or channels along the left and right sidewalls 10A and protruding rail members on the mobile station 20 that the grooves engage and slide along to a locking position. This arrangement could also be reversed, with the protruding rail members extending from the left and right sidewalls 10A that engage slots or grooves made in raised portions of the top cover of the mobile station 20. A Velcro™ backing may also be applied to a bottom major surface 10C the keypad module 11 that engages a corresponding pad or area 20A on the mobile station 20. Other techniques for detachably joining the keypad module 11 to the mobile station 20 may be derived by those skilled in the art, when guided by these teachings.

By whatever engaging mechanism 24 is used, the keypad module 11 can be detachably coupled to the mobile station 20, and used either when attached or when detached for dialing a call, or for entering alphanumeric information in a conventional fashion. In this regard the mobile station 20 is assumed to include an RF transceiver 25, a controller (e.g., MCU 21) and any other required components. Whether attached to or detached from the mobile station 20, signals are communicated in a wireless fashion from the keypad module 11 to the control unit (e.g., MCU 21) of the mobile station 20, via a mobile station low power RF link circuit 23. The signals indicate which one of telephone keypad keys or buttons 12, or optional other buttons 14, has been depressed by the user.

In the presently preferred embodiment the wireless link between the keypad module 11 and the mobile station 10 is made using a low power RF link, such as one known as Bluetooth. Bluetooth wireless technology provides a low cost, low power, short range radio link that enables digital transmission of data over the globally available 2.4 GHz ISM (Industrial, Scientific and Medical) band. In other embodiments a different type of RF link can be employed, or an infrared (IR) wireless link may be used.

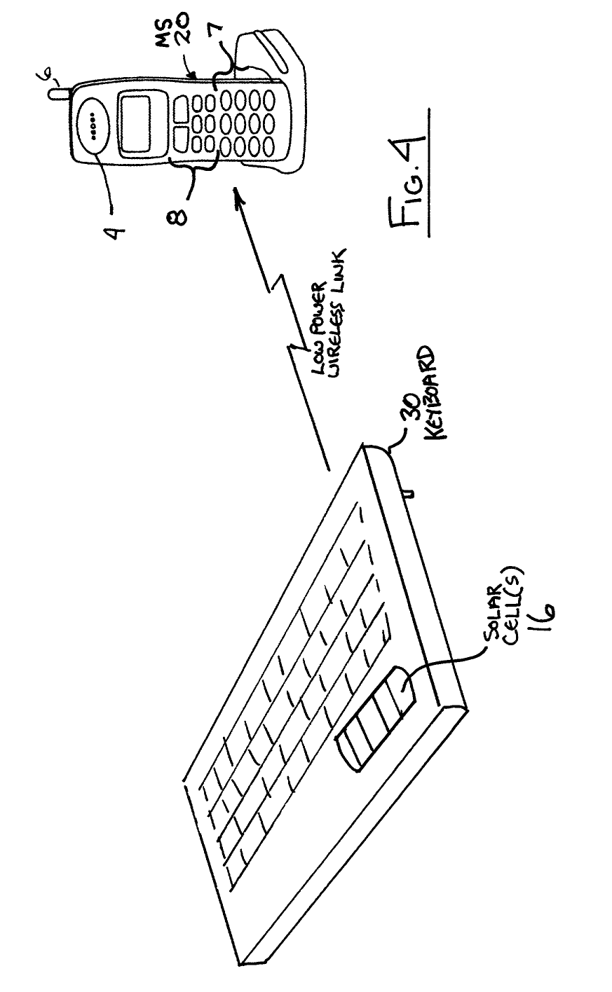

In the presently preferred embodiment of this invention, and referring as well to FIG. 3, the keypad module 11 is powered entirely or partially through the use of the one or more solar cells 16.

Still referring to FIG. 3, the keypad module 11 can include a conventional switch matrix 1 A, wherein depressing one of the buttons 12 or 14 causes a switch closure. A keypad control integrated circuit (IC) 11B scans or reads the matrix 11A for detecting which button has been depressed. An output of the keypad control IC 11B is coupled to a low power RF link circuit 11C that transmits a suitably formatted RF signal to a corresponding low power RF receiver 23 in the mobile station 20. In the preferred embodiment the low power RF link circuit 11C operates in accordance with the Bluetooth protocol and specification (www.bluetooth.com). In this manner the mobile station 20 is made aware of which key or button 12 or 14 the user has depressed, and reacts accordingly. A DC power bus 11E powers the circuits 11B and 11C, and receives power from the solar cell(s) 16, possibly through an optional power supply or power conditioner 11D. An optional battery 11F can be used for powering the keypad module 11 under low light conditions. The battery 11F could be a rechargeable type that is recharged from the solar cell(s) 16. In other embodiments the keypad control IC 11B and the low power RF link IC 11C could be combined into one low power (e.g., CMOS) integrated circuit. In still another embodiment the RF link circuitry could be replaced with IR link circuitry, although an IR link will typically consume more power than the presently preferred RF link.

The arrangement shown in FIGS. 2 and 3 enables the user to remotely operate the mobile station 20, which could be, by example, a handheld cellular telephone, a car phone, a personal communicator, or a mediaphone adapted to work with the keypad module 11. True hands-free operation can be provided, as the user is not required to pickup or physically touch the mobile station 20 to make a call (or to enter data during a call, or to compose an SMS or other type of message). The use of failure-prone wires and connectors to couple the keypad module 11 to the mobile station 20 is also avoided, as no direct electrical connections are required.

When the keypad module 11 is physically connected to or joined with the mobile station 20 the user may operate the mobile station 20 in a conventional fashion. In this case, however, the connection between the keypad module and the mobile station 20 is preferably still made through the low power RF link (e.g., the Bluetooth link). When the keypad module 11 is detached from the mobile station 20, the user employs the keypad module 11 to remotely dial calls and otherwise interact with the mobile station 20, as the low power RF link enables remotely entered user information to be transmitted from the keypad module 11 to the mobile station 20.

The wireless link has been described thus far as a uni-directional link for information flow from the keypad module 11 to the mobile station 20. However, in other embodiments a bi-directional link could be provided if, for example, it was desirable to provide an ability of the mobile station 20 to program or to interrogate the keypad control IC 11B, or to perform diagnostic tests thereon, or for any other reason. It can be appreciated that the underlying wireless link protocol may be inherently bi-directional for enabling acknowledgments to messages and the like to be exchanged. However, the information flow between communicating entities may be uni-directional or bi-directional.

Further in this regard, it is within the scope of these teachings to also provide some type of display capability on the keypad module 11. The display would preferably be a low power type of display, such as an LCD. The display could be used, for example, to simply indicate to the user the number being dialed, and/or call status, or for any other purpose. A simple one line alphanumeric LCD display may be used, or a larger, more elaborate display can be employed. In this case it would be desirable to provide the bidirectional wireless link so that the mobile station 20 could send information to be displayed to the keypad module 11.

While described thus far in the context of a wireless keypad module 11 that is detachable from the mobile station 20, it should be appreciated that it is not necessary that there be any mechanical linkage between the keypad module 11 and the mobile station 20. Furthermore, the mobile station 20 may have a full set of conventional keypad keys and other keys, or a sub-set of the conventional keypad keys and other keys, and still operate with the remote wireless keypad module 11.

Furthermore, and referring to FIG. 4, it can be appreciated that the mobile station 20, which may be constructed to include a conventional keypad 7 and optional other keys 8, may wirelessly communicate with a self-powered full or partial alphanumeric keyboard 30, such as a well-known QWERTY keyboard. The keyboard 30 may have a full complement of alphanumeric keys, special character keys, function keys and the like. In this case, however, it is preferred that the keyboard 30 include the solar cells 16 and possibly also one or more batteries (as in FIG. 3), as well as the wireless link, preferably a low power RF link such as Bluetooth, for transmitting entered keystroke information to the mobile station 20. This embodiment is particularly attractive for composing text messages, such as short message service (SMS) messages and e-mail messages, although telephone calls can be dialed as well. Note that in this embodiment there need be no mechanical connection between the mobile station 20 and the keyboard 30, which is true as well for the embodiments described above for FIGS. 2 and 3.

Thus, while the invention has been particularly shown and described with respect to preferred embodiments thereof, it will be understood by those skilled in the art that changes in form and details may be made therein without departing from the scope and spirit of the invention.

What is claimed is:

1. A mobile station, comprising:
a communication part that comprises a controller, an RF transceiver and an antenna; and
a self-powered information entry part comprising a keypad or keyboard module that is detachable from said communication part and that is coupled, whether attached or detached, through a wireless link to said communication part for conveying keystroke information from said information entry part to said communication part.

2. A mobile station as in claim 1, wherein said wireless link is comprised of an RF link.

3. A mobile station as in claim 1, wherein said wireless link is comprised of a Bluetooth link.

4. A mobile station as in claim 1, wherein said keypad module further comprises a source for providing operating power for said keypad module.

5. A mobile station as in claim 4, wherein said source is comprised of at least one solar cell.

6. A mobile station as in claim 5, wherein said source is further comprised of at least one battery.

7. A keypad module, comprising an engaging mechanism for being detachably coupled to a wireless communication terminal and an interface for being coupled, whether attached or detached, through a wireless link to a wireless communication terminal for conveying keypad-generated information from said keypad module to said wireless communication terminal.

8. A keypad module as in claim 7, wherein said wireless link is comprised of an RF link.

9. A keypad module as in claim 7, wherein said wireless link is comprised of a Bluetooth link.

10. A keypad module as in claim 7, and further comprising a source for providing operating power for said keypad module.

11. A keypad module as in claim 10, wherein said source is comprised of at least one solar cell.

12. A keypad module as in claim 11, wherein said source is further comprised of at least one battery.

13. A method for dialing a telephone number, comprising steps of:
providing a keypad module that is detachably coupled to a wireless communication terminal;
entering information for specifying a telephone number using a keypad on said keypad module; and
whether said keypad module is attached to or detached from said wireless communication terminal, conveying keypad generated information from said keypad module to said wireless communication terminal through a wireless link.

14. A method as in claim 13, and further comprising a step of powering said keypad module using a solar cell located on said keypad module.

15. A mobile station, comprising:
a communication part that comprises a controller, an RF transceiver and an antenna; and
an information entry part comprising a keypad or keyboard module that is separate from said communication part and that is coupled through an RF link to said communication part for conveying keystroke information from said information entry part to said communication part, said module comprising at least one solar cell for powering said module.

16. A mobile station as in claim 15, wherein at least one of said mobile station and said module are adapted for being mechanically attached to one another and detached from one another.

17. An information entry module that comprises a keypad or a keyboard and that further comprises an interface for being coupled through a wireless link to a wireless communication terminal for conveying user-generated keystroke information from said module to said wireless communication terminal, said module further comprising at least one solar cell for powering said module.

18. An information entry module as in claim 17, wherein at least one of said wireless communication terminal and said module are adapted for being mechanically attached to one another and detached from one another.

19. An information entry module as in claim 17, wherein said wireless link is a uni-directional link.

20. An information entry module as in claim 17, wherein said wireless link is a bidirectional link.
